(19) United States
(12) Patent Application Publication
(10) Pub. No.: US 2004/0216368 A1
(43) Pub. Date: Nov. 4, 2004

(54) Rodent trap device

(76) Inventors: Arthur W. Simpson, Honolulu, HI (US); Richard V. Price, Pukalani, HI (US)

Correspondence Address: Vic Y. Lin, MYERS DAWES ANDRAS & SHERMAN LLP, Suite 1150, 19900 MacArthur Blvd., Irvine, CA, 92612, US

(21) Appl. No.: 10/825,018

(22) Filed: Apr. 15, 2004

Related U.S. Application Data
(60) Provisional application No. 60/463,258, filed on Apr. 15, 2003.

(51) Int. Cl. A01M 23/04

(52) U.S. Cl. 43/114

(57) ABSTRACT

A rodent trap device includes an elongate tube and a pair of end caps that form a watertight and/or airtight seal with the tube. An adhesive material is radially disposed on an inner surface of the tube at a central portion thereof. Each end cap includes a circumferential flange that conforms to a cross-sectional profile of the tube so as to facilitate a watertight and/or airtight seal. The device terminates a trapped rodent by drowning or suffocation. A water-activated antibacterial disinfectant is disposed on an inner surface of either end cap. The tube includes one or more axial flat portions such that the tube may be placed on the ground and up against a wall. A method for terminating a rodent by drowning or suffocation is also provided.

### RELATED APPLICATION

The present application is related to U.S. Provisional Patent Application Ser. No. 60/463,258, filed on Apr. 15, 2003, which is incorporated herein by reference and to which priority is claimed pursuant to 35 USC § 119.

### BACKGROUND OF THE INVENTION

1. Field of the Invention

The invention relates generally to pest control and, more particularly, to rat traps.

2. Description of Prior Art and Related Information

Existing rodent traps include sticky traps that adhere to a rodent upon contact. The sticky trap with the rodent adhered thereto is then discarded with no further action being taken. The rodent is then left to suffer in its plight. Users do not like to handle the traps once a mouse or rat has been caught for fear of being touched, bitten or scratched and thereby contracting disease, and also for fear of making eye contact with the rodent.

One major drawback with sticky rodent traps in the prior art, also known as glueboards, is the prolonged suffering the trapped rodent must endure, which includes dehydration, starvation or literally crawling out of its skin in an attempt to escape. Some traps composed of cardboard hide the trapped rodent from immediate view, but offer no alleviation of the suffering of the rodent.

### SUMMARY OF THE INVENTION

In accordance with the present invention, structures and methods are disclosed which overcome the deficiencies of the prior art.

In one aspect, a rodent trap device is provided. The device is particularly adapted to terminate a rodent by drowning or suffocation. The device comprises an elongate tube having a cross-dimension sufficient to enable a rodent to pass through. The tube includes an inner tube surface and an outer tube surface. The tube defines a first open end and a second, opposite open end. An adhesive material is sufficiently disposed on the inner tube surface, preferably along a central portion of the inner tube surface, to trap a rodent traveling through the tube. A first end cap is configured to close the first open end and form a substantially watertight and/or airtight seal therewith. A second end cap is configured to close the second open end and form a substantially watertight and/or airtight seal therewith.

The device further comprises a disinfectant disposed on an inner surface of either of both end caps. The device comprises a first axial flat portion and a second axial flat portion which may be perpendicular to the first axial flat portion. The device may also comprise a rodent attractant disposed within the tube.

The cross-dimension of the tube may be configured to enable a rat or mouse to freely run therethrough until it encounters the adhesive material. Preferably, the tube, first end cap and second end cap are each composed of plastic.

The tube has a cross-sectional profile. Each cap comprises a circumferential flange that conforms to the cross-sectional profile of the corresponding open end of the tube. Each end cap comprises a shoulder adapted to abut an end surface of the tube.

In another aspect, a rodent trap device comprises an elongate tube defining a first open end, a second, opposite open end, and a cross-sectional profile. The tube has a cross-dimension sufficient to enable a rodent to pass through, an inner tube surface and an outer tube surface. An adhesive material is sufficiently disposed on the inner tube surface to trap a rodent traveling through the tube. A first end cap is configured to close the first open end and form a substantially watertight and/or airtight seal therewith. The first end cap includes a first circumferential flange that conforms to the cross-sectional profile of the first open end of the tube. A second end cap is configured to close the second open end and form a watertight seal therewith. The second end cap includes a second circumferential flange that conforms to the cross-sectional profile of the second open end of the tube.

The device further comprises a disinfectant disposed on an inner surface of either of both end caps. The adhesive material is preferably disposed along a central portion of the inner tube surface. The tube comprises a first axial flat portion and a second axial flat portion, which may be perpendicular to each other. The device may further comprise a rodent attractant disposed within the tube.

A method is also provided for terminating rodents by drowning or suffocation. The method comprises the steps of allowing, or enticing, a rodent to enter a tube with a first open end and a second open end, trapping the rodent inside the tube with an adhesive material disposed on an inner surface of the tube, and closing the first open end of the tube to form a first seal.

If the desired approach is suffocation, the first seal is an airtight seal. Thus, the step of closing the first open end of the tube to form the first seal comprises preventing air from escaping the first open end of the tube. The method then comprises closing the second open end of the tube to form a second seal which is also airtight. Accordingly, the step of closing the second open end of the tube to form the second seal comprises preventing air from escaping the second open end of the tube.

If the desired approach is drowning, the first seal is a watertight seal. The tube is then filled with water after closing the first open end of the tube to form a first watertight seal. Accordingly, the step of closing the first open end of the tube to form the first seal comprises preventing the water from escaping the first open end of the tube. The method then comprises the step of closing the second open end of the tube to form a second watertight seal that prevents the water from escaping the second open end of the tube. The method may also comprise activating a disinfectant upon contact with the water.

In summary, a rodent trap device includes an elongate tube and a pair of end caps that form a watertight and/or airtight seal with the tube. An adhesive material is radially disposed on an inner surface of the tube at a central portion thereof. Each end cap includes a circumferential flange that conforms to a cross-sectional profile of the tube so as to facilitate a watertight and/or airtight seal. The device terminates a trapped rodent by drowning or suffocation. A water-activated antibacterial disinfectant is disposed on an inner surface of either end cap. The tube includes one or more axial flat portions such that the tube may be placed on the ground and up against a wall. A method for terminating a rodent by drowning or suffocation is also provided.

The invention, now having been briefly summarized, may be better visualized by turning to the following drawings wherein like elements are referenced by like numerals.

### BRIEF DESCRIPTION OF THE DRAWINGS

FIG. 1 is an exploded view of a preferred embodiment of a rodent trap device according to the invention;

FIG. 2 is a side elevation view of a preferred cap;

FIG. 3 is a perspective view of a the preferred cap; and

FIG. 4 is a diagram of a preferred method of terminating a rodent by drowning or suffocation.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

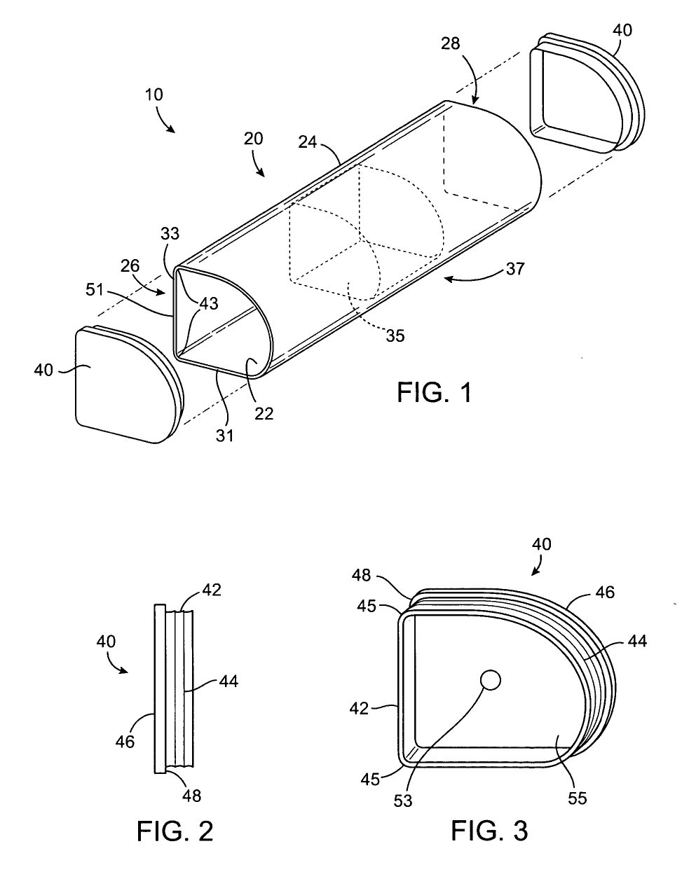

FIG. 1 is an exploded view of a preferred embodiment of a rodent trap device, 10. The device 10 is particularly configured to terminate a rodent by drowning or suffocation. The device 10 comprises an elongate tube 20 having an inner surface 22, outer surface 24, a first open end 26 and a second, opposite open end 28. The open ends 26, 28 are large enough to permit a rodent to enter. The cross-dimension of the tube 20 is large enough such that the rodent may run through until it encounters the adhesive material 35 as discussed below. The tube 20 may be composed of a plastic material and extruded to form the desired shape.

In a preferred embodiment, the tube 20 comprises a first axial flat portion 31 and a second axial flat portion 33. The axial flat portions 31, 33 are substantially perpendicular to each other such that the tube 20 may be placed on the ground against a wall.

An adhesive material 35 is disposed on the inner tube surface 22, preferably in a radial fashion along a central portion 37 of the tube. The adhesive material 35 is preferably disposed along the central radial portion 37 of the tube 20 so as to enable a rodent to completely enter the tube 20 before getting stuck. Accordingly, the tube 20 is preferably long enough to encapsulate a rodent when the rodent engages the sticky central portion 37 and thus gets stuck. As described further below, this facilitates the closing of the tube 20 without having to make any physical contact with the rodent. The adhesive strength of the material 35 is strong enough to cause a rodent to adhere to the inner surface 22 upon contact.

The device 10 also comprises a pair of end caps 40 that are preferably configured to form a watertight and/or airtight seal with the tube 20. As shown in FIGS. 2-3, each end cap 40 includes a circumferential flange 42 that conforms to the cross-sectional profile of the inner surface 22 of the tube 20. If the tube 20 comprises an asymmetrical cross-sectional profile as shown in the illustrated embodiment in FIG. 1, then the end caps 40 are mirror images of each other. Accordingly, the circumferential flange 42 of a first end cap 40 would conform to the cross-sectional profile of the first open end 26, while the circumferential flange 42 of a second end cap 40 would conform to the cross-sectional profile of the second open end 28. If, for example, if the tube 20 is provided with a symmetrical cross-sectional profile such as a rectangle, then both caps 40 would be identical and each flange 42 would also comprise a conforming rectangular shape. To facilitate a watertight and airtight seal, corners 43 of the tube are preferably rounded. Accordingly, each flange 42 also includes conforming rounded corners 45 as shown in FIG. 3. Each flange 42 may be optionally configured with ridges 44 that facilitate a tight friction fit with the inner surface 22 of the tube 20. Each cap 40 also comprises an outer lid 46 that includes a shoulder 48 configured to abut an end surface 51 of the tube 20.

The device 10 may also include a water-activated anti-bacterial disinfectant 53 disposed on the inner surface 22 of the tube 20 or, preferably, on an inner surface 55 of either cap 40. By disposing the disinfectant 53 on an inner surface 55 of one or both of the caps 40, the disinfectant 53 is kept from being dissipated or otherwise affected by a rodent trapped within the tube 20. Additionally, placing the disinfectant 53 on either of the caps 40 prevents the smell of the disinfectant 53 from tainting the inside of the tube 20 and alerting or repelling the rodent by its smell.

The tube 20 may be manufactured in different sizes to accommodate different rodents. For example, a tube 20 with a slightly larger cross-sectional profile may be provided for rats, and a smaller profile for mice. Depending upon the needs of the user, the appropriately sized tube 20 can be used so as to encourage the rodent enter the tube 20.

The device 10 may include one or more attractants in the tube 20 to entice a rodent to enter. Such attractants may include light reflecting components such as mirrors, glitter, glow-in-the-dark materials, and other such materials. Other attractants may also be employed either alone or in combination with one another, including food, food odors, sex attractants, flower, flower odors, and more.

In operation, the tube 20 is disposed along a surface where rodents traverse. This may include the ground, countertops, cabinets and any other surface, whether indoor or outdoor. The tube 20 is placed without the caps 40 so as to expose both open ends 26, 28. When a rodent enters the tube 20, the adhesive material 35 will stick to the rodent causing the rodent to be trapped within the tube 20. Once trapped in the tube 20, the user closes one of the open ends 26, 28 with a corresponding end cap 40. The tube 20 is then filled with water through the remaining open end 26 or 28, which effectively and immediately terminates the rodent by drowning. Lastly, the user closes the remaining open end 26 or 28 with the other corresponding end cap 40 to seal the water in the tube 20, thereby drowning the rodent and promptly ending its suffering. The water in the tube 20 also activates the antibacterial disinfectant, thereby minimizing the spread of germs and disease. Once sealed, the device 10 may simply be discarded.

Though not shown, it should be expressly understood that a variety of mechanical means may be employed to prevent the end caps 40 from becoming accidentally dislodged once installed onto the tube 20. As examples and not by way of limitations, the device 10 may include a ratchet mechanism on the cap that cooperates with a detent in the tube, a hook-and-loop mechanism, fasteners, catches, and a variety of other known coupling means.

It will be appreciated that not only is the suffering of the rodent minimized, sanitation is greatly enhanced as the user can avoid all physical contact with the rodent. The use of a disinfectant also serves to mitigate the contagion of vector borne disease. Furthermore, since one of the major drawbacks of handling rat traps is the sight of the captured rodent, the device 10 according to the invention improves convenience by minimizing any eye contact that the user needs to make with the rodent.

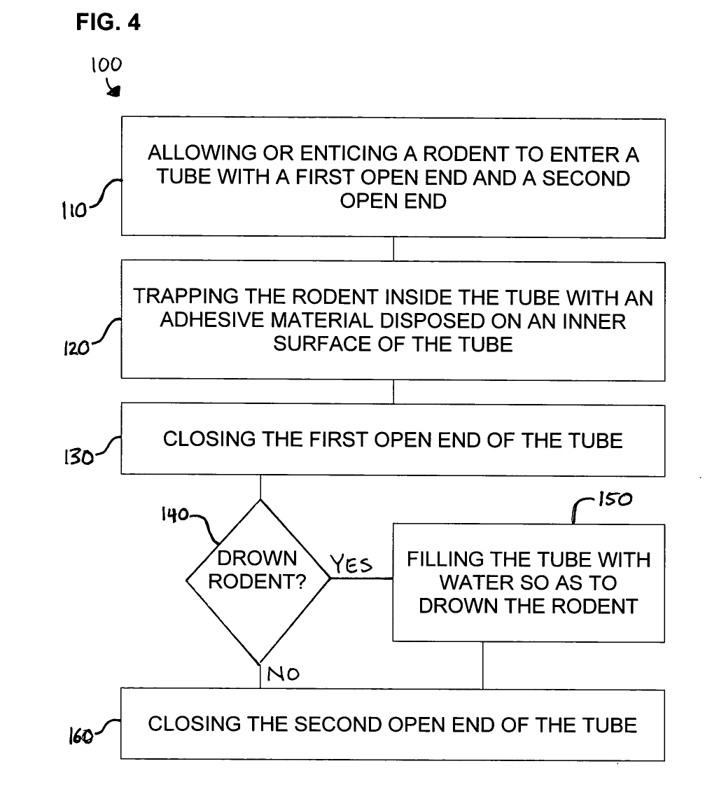

It will be further appreciated that a preferred method for terminating a rodent by drowning or suffocation is provided according to the invention. In FIG. 4, the method 100 comprises the step 110 of allowing, or enticing, a rodent to enter a tube with a first open end and a second open end. In step 120, the rodent is trapped inside the tube with an adhesive material disposed on an inner surface of the tube. In step 130, the first open end of the tube is closed to form a first seal.

At step 140, the user determines whether to terminate the trapped rodent by drowning or suffocation. If drowning is chosen, step 150 is employed which comprises filling the tube with water so as to effectively and immediately drown the rodent. In step 160, the second open end of the tube is closed to form a second seal. If suffocation is chosen, step 150 is skipped, and the method proceeds from step 140 to step 160.

If drowning is chosen, the first seal in step 130 is a first watertight seal wherein closing the first open end of the tube comprises preventing the water from escaping the first open end of the tube; and the second seal in step 160 is a second watertight seal wherein closing the second open end of the tube comprises preventing the water from escaping the second open end of the tube. The method may also comprise a step of activating a disinfectant upon contact with the water.

If suffocation is chosen, the first seal in step 130 is a first airtight seal wherein closing the first open end of the tube comprises preventing air from escaping the first open end of the tube; and the second seal in step 160 is a second airtight seal wherein closing the second open end of the tube comprises preventing air from escaping the second open end of the tube.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A rodent trap device, comprising:
an elongate tube having a cross-dimension sufficient to enable a rodent to pass through, an inner tube surface and an outer tube surface, the tube defining a first open end and a second, opposite open end;
an adhesive material sufficiently disposed on the inner tube surface to trap a rodent traveling through the tube; and
a first end cap configured to close the first open end and form a watertight seal therewith; and
a second end cap configured to close the second open end and form a watertight seal therewith.

2. The device of claim 1, further comprising a disinfectant disposed on an inner surface of either of the first end cap and the second end cap.

3. The device of claim 1, wherein the adhesive material is disposed along a central portion of the inner tube surface.

4. The device of claim 1, wherein the tube comprises a first axial flat portion.

5. The device of claim 4, wherein the tube comprises a second axial flat portion.

6. The device of claim 1, further comprising a rodent attractant disposed within the tube.

7. The device of claim 1, wherein the cross-dimension of the tube is configured to enable a rat to travel therethrough.

8. The device of claim 1, wherein the cross-dimension of the tube is configured to enable a mouse to travel therethrough.

9. The device of claim 1, wherein:
the tube has a cross-sectional profile; and
each cap comprises a circumferential flange that conforms to the cross-sectional profile of the tube.

10. The device of claim 9, wherein each end cap comprises a shoulder adapted to abut an end surface of the tube.

11. The device of claim 1, wherein:
the first end cap is configured to form a first airtight seal with the first open end; and
a second end cap configured to form a second airtight seal with the second open end.

12. A rodent trap device, comprising:
an elongate tube having a cross-dimension sufficient to enable a rodent to pass through, an inner tube surface and an outer tube surface, the tube defining a first open end with a first cross-sectional profile, and a second, opposite open end with a second cross-sectional profile;
an adhesive material sufficiently disposed on the inner tube surface to trap a rodent traveling through the tube; and
a first end cap configured to close the first open end and form a first seal therewith, the first end cap including a first circumferential flange that conforms to the first cross-sectional profile; and
a second end cap configured to close the second open end and form a second seal therewith, the second end cap including a second circumferential flange that conforms to the second cross-sectional profile.

13. The device of claim 12, further comprising a disinfectant disposed on an inner surface of the either of the first end cap and the second end cap.

14. The device of claim 12, wherein the adhesive material is disposed along a central portion of the inner tube surface.

15. The device of claim 12, wherein the tube comprises a first axial flat portion.

16. The device of claim 15, wherein the tube comprises a second axial flat portion perpendicular to the first axial flat portion.

17. The device of claim 12, further comprising a rodent attractant disposed within the tube.

18. The device of claim 12, wherein:
the first seal comprises a first watertight seal; and
the second seal comprises a second watertight seal.

19. The device of claim 12, wherein:
the first seal comprises a first airtight seal; and
the second seal comprises a second airtight seal.

20. The device of claim 12, wherein:
the first seal comprises a first watertight and airtight seal; and
the second seal comprises a second watertight and airtight seal.

21. A method for terminating rodents, comprising:
allowing a rodent to enter a tube with a first open end and a second open end;
trapping the rodent inside the tube with an adhesive material disposed on an inner surface of the tube;
closing the first open end of the tube to form a first seal; and
closing the second open end of the tube to form a second seal.

22. The method of claim 21, further comprising filling the tube with water after closing the first open end of the tube to form the first seal.

23. The method of claim 22, wherein:
closing the first open end of the tube to form the first seal comprises preventing the water from escaping the first open end of the tube; and
closing the second open end of the tube to form the second seal comprises preventing the water from escaping the second open end of the tube.

24. The method of claim 22, further comprising activating a disinfectant upon contact with the water.

25. The method of claim 21, wherein:
closing the first open end of the tube to form the first seal comprises preventing air from escaping the first open end of the tube; and
closing the second open end of the tube to form the second seal comprises preventing air from escaping the second open end of the tube.
